(19) United States
(12) Patent Application Publication
(10) Pub. No.: US 2021/0031589 A1
(43) Pub. Date: Feb. 4, 2021

(54) ELECTRIC VEHICLE THERMAL MANAGEMENT SYSTEM FOR HOT CLIMATE REGIONS

(71) Applicant: PRANAV VIKAS (INDIA) PVT. LTD., NIT Faridabad (IN)

(72) Inventors: Yuji YAMAMOTO, Gurgaon (IN); Tarun ., Hisar (IN)

(73) Assignee: Pranav Vikas (India) Pvt. Ltd., NIT Faridabad (IN)

(21) Appl. No.: 16/963,551

(22) PCT Filed: Apr. 6, 2018
(86) PCT No.: PCT/IB2018/052392

§ 371 Date: Jul. 21, 2020

(30) Foreign Application Priority Data
Jan. 24, 2018 (IN) 201811002807

(51) Int. Cl. B60H 1/00; B60H 1/32

(52) U.S. Cl. CPC B60H 1/00392; B60H 1/00278; B60H 1/00428; B60H 1/00492; B60H 1/32281; B60H 1/00885; B60H 1/3208; B60H 1/3222; B60H 1/0073

(57) ABSTRACT

The present subject matter relates to an electric vehicle thermal management system comprising at least one air conditioning system and a battery thermal management system, with a battery, for being used in hot climate region. The system comprising: a refrigerant cycle comprising a compressor, a first condenser, a second condenser; expansion devices, and an evaporator, wherein the compressor being configured to compress refrigerant vapours by increasing temperature and pressure of a refrigerant; and wherein the first condenser and the second condenser being configured to condense high pressure and high temperature of the refrigerant; and a coolant cycle comprising an electric water pump, a battery heat exchanger, the first condenser, and a heater, wherein the electric water pump being configured to pump a coolant into the coolant cycle, the first condenser being configured to heat the coolant using the heat captured from the refrigerant cycle and configured to transfer the heated coolant to the heater.

### TECHNICAL FIELD

The present subject matter described herein, in general, relates to the field of thermal management system of an electric vehicle and in particular, relates to an electric vehicle thermal management system used in hot climate region.

### BACKGROUND

Nowadays, an air conditioning system is necessary to be provided in an electric vehicle for the comfort of the driver and the passengers, especially for hot climate regions. This is basic thermal management system. In addition to that, in an electric vehicle, new basic power train thermal management systems are Battery thermal management systems, traction motor cooling system, and inverter cooling system, and the like. Currently, there are several ideas and applications, trying to manage air conditioning system with other thermal management systems.

Those systems known in the art are prioritized to have high energy efficient system, i.e., high coefficient of performance for the heating system. The heating efficiency has been the biggest problem for electric vehicles around the globe, for example, in Europe, the US, Japan, China and so on, where majority of area has moderate or cold climate conditions. For those regions, CO₂=R744 refrigerant based heat pump system will be the best average coefficient of performance solution followed by R134a or R1234yf refrigerant heat pump system. But this kind of systems are not always the best for hot regions like, India, Gulf coast counties, Thailand, a part of Africa, and the countries closer to equator, where majority of area has hot climate conditions. For these regions, heat pump system is not suitable requiring special heat exchangers, valves and pipes to switch modes and to control the system efficiently, this complicate system is penalizing cooling mode COP due to additional pressure drops by additional components. Especially, carbon dioxide heat pump system is the worst for that regions due to lowest cooling mode coefficient of performance.

Since the electric vehicle thermal management system is the second biggest energy consumer in electric vehicle after propulsion system, it is very important to have a highly energy efficient system for the aimed regions, not deteriorating too much driving mileage per one time full battery charge. But at the same time, the electric vehicle thermal management system should be reasonably affordable adapting to the aimed regions as well.

Thus, there is a need for integrated electric vehicle thermal management system which can be used in hot climate region having a high energy efficiency and good driving mileage.

### SUMMARY

It is an object of the present subject matter to provide an electric vehicle thermal management system capable of integration of at least one air conditioning system and other several thermal management systems into one.

It is an object of the present subject matter to provide an electric vehicle thermal management system capable to manage heat transfers using vapour compression refrigeration cycle.

It is another object of the present subject matter to provide an electric vehicle thermal management system capable to remove air-mix architecture in an HVAC (Heating, Ventilation and Air Conditioning) unit.

It is another object of the present subject matter to provide an electric vehicle thermal management system of less weight and cost but also less pressure drop at refrigerant circuit or refrigerant cycle.

It is yet another object of the present subject matter to provide an electric vehicle thermal management system having integrated heat recovery heating system which enables better heat pump heating integration.

It is yet another object of the present subject matter to provide an electric vehicle thermal management system having precise temperature control and dehumidified heating mode.

It is yet another object of the present subject matter to provide an electric vehicle thermal management system which can be used in both hot and moderate climate regions.

The present subject matter described herein relates to an electric vehicle thermal management system used in hot climate region. The electric vehicle thermal management system comprising at least one air conditioning system and a battery thermal management system, with a battery, for being used in hot climate region. The system comprising: a refrigerant cycle comprising a compressor, a first condenser, a second condenser; and an evaporator, wherein the compressor being configured to compress refrigerant vapours, increasing temperature and pressure of a refrigerant; and wherein the first condenser and the second condenser being configured to condense high pressure and high temperature of the refrigerant; and a coolant cycle comprising an electric water pump, a battery heat exchanger, the first condenser, and a heater, wherein the electric water pump being configured to pump a coolant into the coolant cycle, the first condenser being configured to heat the coolant using the heat captured from the refrigerant cycle and configured to transfer the heated coolant to the heater.

In an embodiment of the present subject matter, the compressor is powered by the battery to compress refrigerant vapours, increasing temperature and pressure of refrigerant.

In another embodiment of the present subject matter, the first condenser is a common heat exchanger between the refrigerant cycle and the coolant cycle.

In another embodiment of the present subject matter, the first condenser is a water cooled condenser and the second condenser is an air cooled condenser.

In another embodiment of the present subject matter, the refrigerant vapours flows through the first condenser and the second condenser to condense and lower the temperature of the refrigerant vapours.

In another embodiment of the present subject matter, the refrigerant vapours flows from the first condenser and the second condenser to the evaporator through an expansion device and a flow control valve.

In another embodiment of the present subject matter, the electric water pump is powered by the battery to pump the coolant into the coolant cycle.

In another embodiment of the present subject matter, the first condenser is configured to heat the coolant using the waste heat captured by the first condenser from the refrigerant cycle and wherein the coolant flows from the electric water pump to the heater through the first condenser.

In another embodiment of the present subject matter, the inlet coolant of the first condenser is already recovering heat from battery through battery heat exchanger when cabin heating is necessary. Thus, this heating system is totally managed by heat recovery from heat dissipation of the first condenser and the battery when at least either cabin air conditioning including evaporator operation or battery cooling is functioning. Then, no additional heating power using electricity that decreases driving mileage is necessary. Heating is necessary not only in winter season but also in other seasons to reheat air after evaporator in HVAC to control exact air temperature that is commanded by vehicle occupants. So the recovery heating system can provide a benefit for the entire seasons even in hot climate regions, having a necessary capacity to support such a region's requirement.

In another embodiment of the present subject matter, a plurality of compressors and heat exchangers are configured in the refrigerant cycle and the coolant cycle.

In another embodiment of the present subject matter, the refrigerant by-pass passage is configured between before the evaporator and the compressor.

In another embodiment of the present subject matter, the second condenser has an evaporator function with an additional expansion device.

In another embodiment of the present subject matter, the heater outlet temperature coolant is controlled to lower it to the level of a battery heat exchanger.

In another embodiment of the present subject matter, the heater outlet air temperature is controlled by a coolant flow rate control, using flow control valve.

In another embodiment of the present subject matter, the first condenser, the flow control valve and the chiller are assembled directly.

In another embodiment of the present subject matter, a surge tank is configured in the coolant cycle.

In another embodiment of the present subject matter, a phase change material is allocated in the surge tank as heat storage.

In another embodiment of the present subject matter, a traction motor and/or an inverter are connected in parallel to battery to increase recovery heat.

In another embodiment of the present subject matter, a heat exchanger is configured to exchange heat of the refrigerant between the compressor inlet and the expansion device inlet.

In another embodiment of the present subject matter, a system controller is configured to control heater core outlet air temperature by coolant flow rate control, using flow control valve, sensing heater outlet temperature, and battery inlet-outlet coolant temperature difference by coolant flow rate control, using electric pump rotation control logic, sensing compressor inlet & outlet temperature and pressure, and battery inlet coolant temperature control by compressor rotation control logic, and in-car temperature control by compressor rotation control logic, using input from in-car air temperature, evaporator outlet surface or air temperature sensing data.

### BRIEF DESCRIPTION OF ACCOMPANYING DRAWINGS

The foregoing and further objects, features and advantages of the present subject matter will become apparent from the following description of exemplary embodiments with reference to the accompanying drawings, wherein like numerals are used to represent like elements.

It is to be noted, however, that the appended drawings illustrate only typical embodiments of the present subject matter, and are therefore, not to be considered for limiting of its scope, for the subject matter may admit to other equally effective embodiments.

FIG. 1 illustrates an electric vehicle thermal management system including a refrigerant cycle and coolant cycle in accordance with another embodiment of the present subject matter. The said system is adapted, particularly, for hot climate regions.

FIG. 2 illustrates a max cooling state of the electric vehicle thermal management system including a refrigerant cycle and coolant cycle, which is typically used for cooling down period from hot cabin & battery temperature to controlled temperature, in accordance with another embodiment of the present subject matter.

FIG. 3 illustrates a heating mode and a demisting/defrosting mode of the electric vehicle thermal management system, which is typically used for pre-heating the cabin and battery in winter season, in accordance with another embodiment of the present subject matter.

FIG. 4 illustrates a temperature control mode of the electric vehicle thermal management system, which is typically used for generic operation modes using active cooling and recovery heating both functions at the same time, in accordance with another embodiment of the present subject matter.

FIG. 5 illustrates an electric vehicle thermal management system including a refrigerant cycle and coolant cycle in accordance with another embodiment of the present subject matter. The said system is adapted, particularly, for mix of moderate climate and hot climate.

FIG. 6 illustrates a max cooling state of the electric vehicle thermal management system including a refrigerant cycle and coolant cycle, which is typically used for cooling down period from hot cabin & battery temperature to controlled temperature, in accordance with another embodiment of the present subject matter.

FIG. 7 illustrates a heating mode and demisting/defrosting mode the electric vehicle thermal management system, which is typically used for pre-heating the cabin and battery in winter season, in accordance with another embodiment of the present subject matter.

FIG. 8 illustrates a temperature control mode of the electric vehicle thermal management system, which is typically used for generic operation modes using active cooling and recovery heating both functions at the same time, in accordance with another embodiment of the present subject matter.

FIG. 9 illustrates the electric vehicle thermal management system in accordance with another embodiment of the present subject matter. The said system is adapted, particularly, for moderate climate and cold climate regions.

FIG. 10 illustrates a max cooling mode of the electric vehicle thermal management system, which is typically used for cooling down period from hot cabin & battery temperature to controlled temperature, in accordance with another embodiment of the present subject matter.

FIG. 11 illustrates a heating mode & demisting/defrosting mode of the electric vehicle thermal management system, which is typically used for pre-heating the cabin and battery, and generic heating, in winter season, in accordance with another embodiment of the present subject matter.

FIG. 12 illustrates a temperature control mode of the electric vehicle thermal management system, that is typically used for generic operation modes using active cooling and active heating using electric heater both functions at the same time, in accordance with another embodiment of the present subject matter.

FIG. 13 illustrates the electric vehicle thermal management system with Inverter heat exchanger and traction motor heat exchanger, to have more heat recovery for heating function, in parallel in accordance with another embodiment of the present subject matter.

### DETAILED DESCRIPTION

The following presents a detailed description of various embodiments of the present subject matter with reference to the accompanying drawings.

The embodiments of the present subject matter are described in detail with reference to the accompanying drawings. However, the present subject matter is not limited to these embodiments which are only provided to explain more clearly the present subject matter to a person skilled in the art of the present disclosure. In the accompanying drawings, like reference numerals are used to indicate like components.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “attached” or “connected” or “coupled” or “mounted” to another element, it can be directly attached or connected or coupled to the other element or intervening elements may be present. As used herein, the term “and/or” includes any and all combinations and arrangements of one or more of the associated listed items.

The figures depict a simplified structure only showing some elements and functional entities, all being logical units whose implementation may differ from what is shown.

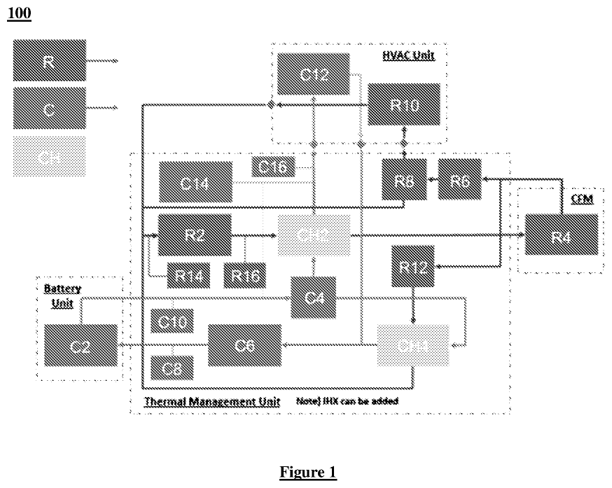

FIG. 1 illustrates an electric vehicle thermal management system 100 including a refrigerant cycle R and coolant cycle C in accordance with an embodiment of the present subject matter. The said system 100 is adapted, particularly, for hot climate regions.

The electric vehicle thermal management system 100, described herein, relates to an integrated system comprising at least one AC system and a battery thermal management system. The system, in an embodiment, may integrate thermal management systems of traction motor, inverter and the like.

In an embodiment, as can be seen in FIG. 1, the integrated system 100 comprises a battery unit, a thermal management unit, a HVAC (Heating, Ventilation and Air Conditioning) unit, and a condenser which are interconnected with each other. The system employs basic principles of vapour compression refrigerant cycle R and coolant cycle C along with a coolant heat exchanger CH.

In an embodiment of the present subject matter, the first closed refrigerant cycle R comprises an electric compressor R2, a first condenser or a water cooled condenser CH2, a second condenser or an air cooled condenser R4, an electric expansion device (EXV) R6, a flow control valve R8, an evaporator R10 and a plurality of connecting pipes for connecting the components with each other. The compressor R2, which is powered by a battery, compresses the refrigerant vapour thereby increasing temperature and pressure of refrigerant. The two condensers CH2, R4 are condensing high pressure and high temperature refrigerant using coolant and air respectively, which are coming from the second closed coolant cycle C, and ambient air. The electric expansion device R6 is used to control the refrigerant pressure, temperature and refrigerant flow before the compressor R2 under the integrated system 100 controlling logic. Further, pressure and temperature sensors, arranged before and after compressor R2, can be used as the controller input data. The flow control valve R8, arranged in between electric expansion device R6 and the evaporator R10, is used to switch the refrigerant flow to the evaporator R10 for cooling mode C or by-passing evaporator R10 for pre-conditioning heating or starting up heating mode.

In a simultaneous embodiment of the present subject matter, the second closed coolant cycle C comprises an electric water pump C6, a battery heat exchanger C2, the water cooled condenser CH2, a heater core C12 or an HVAC heater C12, a surge tank C14, a chiller CH4, and plurality of connecting pipes for connecting the components with each other. The water pump C6, powered by a battery, is used to pump the coolant, which is typically a mixture of water, ethylene glycol and some additives thereby flowing it through heat exchangers in the coolant cycle C. The water cooled condenser CH2 is the common heat exchanger between two closed cycles R, C. For the coolant cycle C, the water cooled condenser CH2 is acting as a coolant heater using waste heat from first closed cycle R, providing hot or warm coolant to heater core C12. Further, using a flow control valve C4 before water cooled condenser CH2, coolant flow is being controlled having input temperature data before or after HVAC heater core C12, based on the integrated system controlling logic to give minimum required heating energy. Returning coolant temperature from heater core C12 to main coolant line before coolant pump is to be controlled as similar as the temperature before or after battery heat exchanger C2 so that it can minimize an impact to battery cooling coolant cycle C. Required heating energy is to be controlled by coolant flow rate controlled by coolant flow control valve. Since heater core inlet and outlet temperature difference will be significantly larger and the coolant flow rate will be significantly lower, than typical heater core application, multi pass cross counter flow heater core usage is preferable. Battery temperature control can be done with the integrated system controlling logic. Inlet and outlet coolant temperature sensors can be used for the controller input data as well as battery temperature itself. Since this coolant cycle C can operate in parallel to refrigerant cycle R, the HVAC heater C12 can have temperature control, which is cooling and is dehumidifying by the evaporator R10 first then re-heating by heater core. Re-heating will be controlled as minimum for energy saving point of view but it is necessary to adjust relative humidity and to prevent uncomfortable smell generation from evaporator having an upper limit of evaporator outlet air temperature. If the evaporator R10 surface temperature is beyond the limit, the evaporator R10 surface will start drying the water condensation. At that time, smell source substances trapped from air will be de-touched to the air again which will be sensed by occupants as uncomfortable smell. Thus, re-heating, depending on the user desired setting air temperature in the cabin, is required. The battery heat exchanger C2 also can control the temperature properly including heating.

In addition to heat recovery heating system, active heating system using Hot Gas By-Pass heating system is included in this system 100, which might be necessary for the electric vehicle pre-conditioning heating or start up short period in winter season even in some of hot climate regions. Further, using flow control valve R8 between electric expansion device R6 and the evaporator R10, the refrigerant can by-pass evaporator, not cooling cabin in cold condition, then after the compressor R2, in the water cooled condenser CH2, generated heat in compression operation can be transferred to coolant for HVAC and Battery heating. Although, this function can be removed easily for extreme hot climate regions by removal of by-pass pipe and flow control valve before evaporator between valve and compressor.

In another embodiment of the present subject matter, a low pressure and temperature sensor (LPTS) R14 and a high pressure and temperature sensor (HPTS) R16 are arranged before and after the compressor R2. Further, a battery outlet temperature sensor (BOTS) C10 and a battery inlet temperature sensor (BITS) C8 is also arranged in the coolant cycle C to measure the temperature of the coolant when the coolant goes out and goes into the battery thermal management heat exchanger C2. Furthermore, a heater inlet temperature sensor (HITS) C16 is arranged in between the flow path of HVAC heater C12 and the water cooled condenser CH2. The heater inlet temperature sensor (HITS) C16 can be arranged in between the flow path of the HVAC heater C12 and coolant main stream line between the electric water pump C6 and the water cooled condenser CH4.

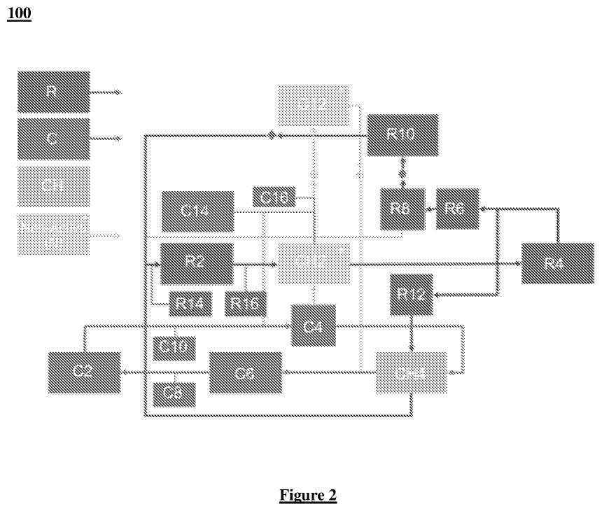

FIG. 2 illustrates a max cooling state of the electric vehicle thermal management system 100 including a refrigerant cycle R and coolant cycle C, which is typically used for cooling down period from hot cabin & battery temperature to controlled temperature, in accordance with another embodiment of the present subject matter.

In this embodiment of the present subject matter, the water cooled condenser CH2 and the heater C12 may be in non-active state because max cooling does not require heating function, by shutting off coolant flow to the heater core with coolant side flow control valve.

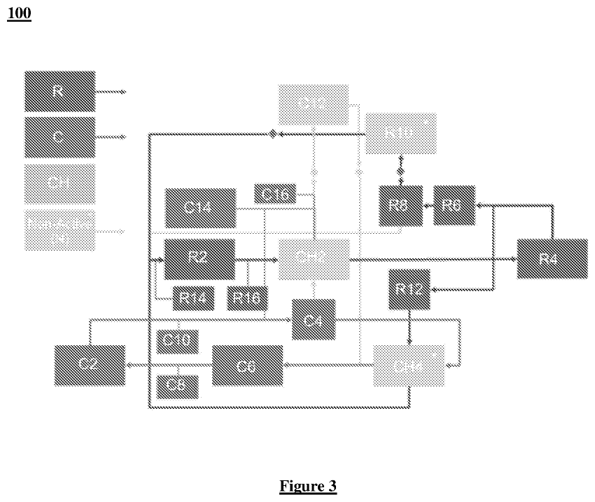

FIG. 3 illustrates a heating mode and a demisting/defrosting mode of the electric vehicle thermal management system 100, which is typically used for pre-heating the cabin and battery in winter season, in accordance with another embodiment of the present subject matter.

In this embodiment of the present subject matter, the evaporator R10 and the chiller CH4 may be in non-active state because pre-heating or start up heating does not require cooling devices, by shutting off the refrigerant to the evaporator R10 by flow control valve and the refrigerant to the chiller CH4 by the expansion device R12.

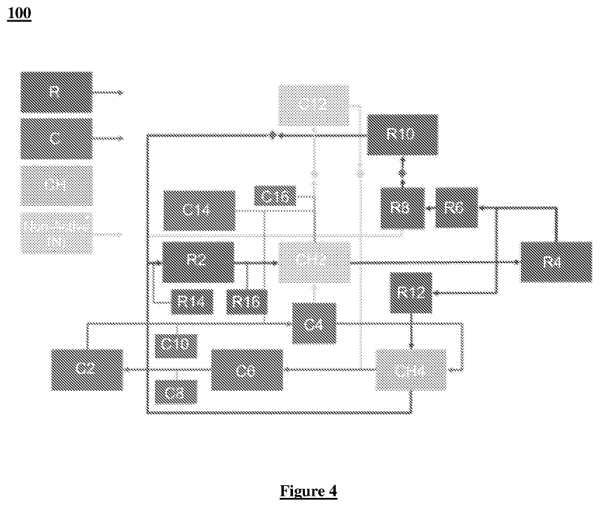

FIG. 4 illustrates a temperature control mode of the electric vehicle thermal management system 100, which is typically used for generic operation modes using active cooling and recovery heating both functions at the same time, in accordance with another embodiment of the present subject matter.

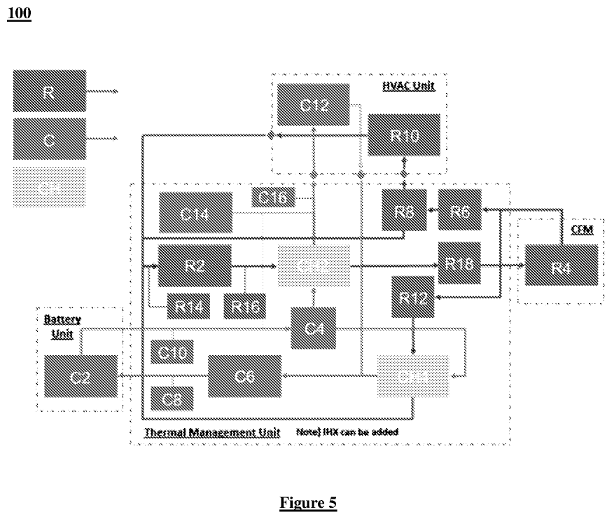

FIG. 5 illustrates an electric vehicle thermal management system 100 including a refrigerant cycle R and coolant cycle C in accordance with another embodiment of the present subject matter. The system of this embodiment is adapted, particularly, for mix of moderate climate and hot climate.

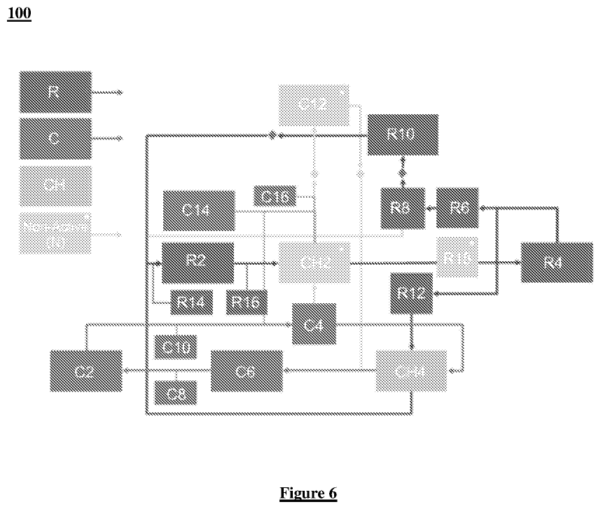

In an another embodiment of the present subject matter, as can be seen in FIG. 5, an integrated system for air conditioner and battery cooling is using heat pump system in refrigerant cycle R. In comparison to the first embodiment of present subject matter as illustrated in FIG. 1, an additional electric expansion device R18 is used for the evaporator mode of the air cooled condenser/evaporator R4. For heating mode, it can absorb the energy from ambient air for better coefficient of performance. But for the evaporator mode, it requires additional expansion device R18 also which should be inoperative during cooling mode as can be seen in FIG. 6. This additional expansion device R18 should have full open function to avoid an additional by-pass circuit to minimize additional pressure drop which decrease cooling mode efficiency. Thus, this system is better for mix of moderate climate and hot climate, balancing heating mode efficiency and cooling mode efficiency. To minimize the components in the system, accumulator (not seen in FIG. 6) is removed from this embodiment, expecting electric expansion device R18 can prevent flow of the liquid back to compressor R2. To mitigate the potential risk of liquid back, an internal heat exchanger (IHX) can be arranged between high pressure liquid line before the electric expansion device R18 and low pressure vapour line before compressor R2. This will vaporize the liquid refrigerant thanks to temperature increase caused by heat transfer from high pressure high temperature refrigerant. At the same time, system efficiency and/or performance also can be improved. The internal heat exchanger (IHX) application is applicable for FIG. 1 embodiment also. In any case, depending on the system behavior, accumulator can be added as normal heat pump system for this heat pump application.

FIG. 6 illustrates a max cooling state of the electric vehicle thermal management system including a refrigerant cycle R and coolant cycle C, which is typically used for cooling down period from hot cabin & battery temperature to controlled temperature, in accordance with another embodiment of the present subject matter.

In this embodiment of the present subject matter, the water cooled condenser CH2 along with the additional electric expansion device R18 and the heater C12 may be in non-active state because max cooling does not require heating function, by shutting off coolant flow to the heater core with coolant side flow control valve.

Further, all additional components will create additional pressure drops which deteriorate cooling mode coefficient of performance.

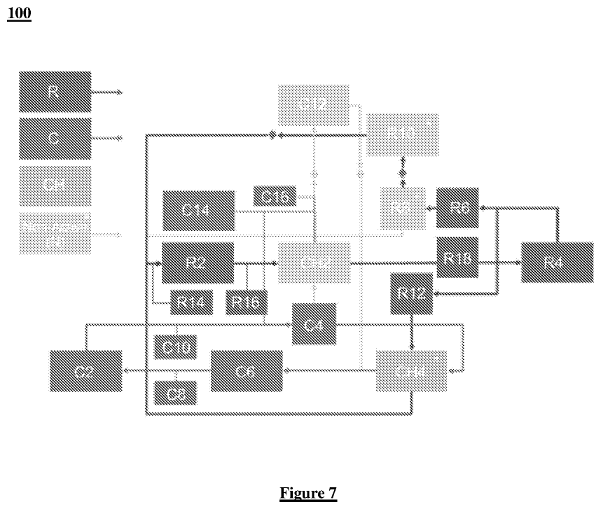

FIG. 7 illustrates a heating mode and demisting/defrosting mode the electric vehicle thermal management system 100, which is typically used for pre-heating the cabin and battery in winter season, in accordance with another embodiment of the present subject matter.

In this embodiment of the present subject matter, the evaporator R10, along with the electric expansion device R8, is connected with the chiller CH4. The chiller CH4 and the evaporator R10, along with the electric expansion device R8, may be in non-active state because pre-heating or start up heating does not require cooling devices, by shutting off the refrigerant to the evaporator R10 by flow control valve R6 and the refrigerant to the chiller CH4 by the electric expansion device.

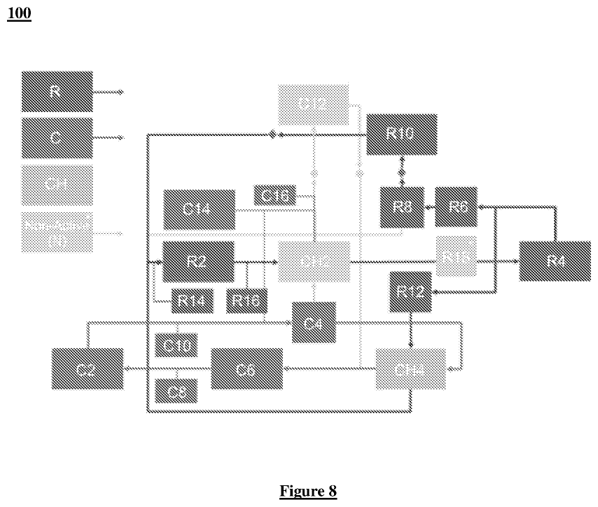

FIG. 8 illustrates a temperature control mode of the electric vehicle thermal management system 100, which is typically used for generic operation modes using active cooling and recovery heating both functions at the same time, in accordance with another embodiment of the present subject matter.

In this embodiment of the present subject matter, the additional electric expansion device R18 may be in non-active state. This additional expansion device R18 should fully opened to minimize additional pressure drop which decrease cooling mode efficiency. Or it is necessary to allocate a by-pass line of the expansion device. In any case, the pressure drop is higher than that of FIG. 1. Thus, this system is better for mix of moderate climate and hot climate, balancing heating mode efficiency and cooling mode efficiency.

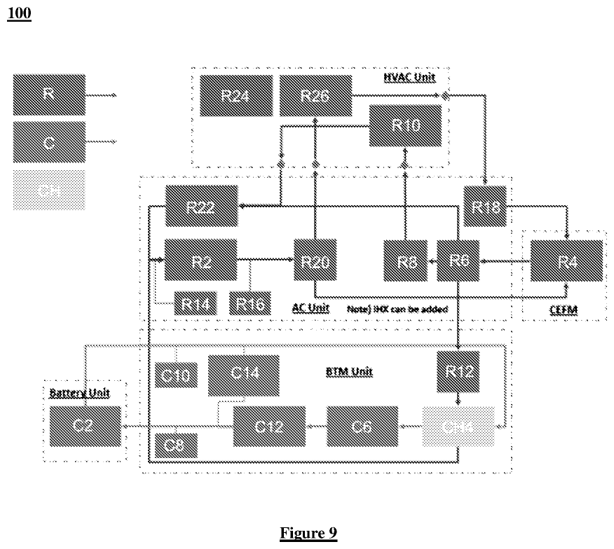

FIG. 9 illustrates the electric vehicle thermal management system 100 in accordance with another embodiment of the present subject matter. The said system is adapted, particularly, for moderate climate and cold climate regions.

In another embodiment of the present subject matter, as can been seen in FIG. 9, a typical separated system for air conditioner and the battery thermal management system uses exclusive heat pump system at air conditioning system. Only the compressor and cooling unit (CEFM) are shared. This embodiment requires independent accumulator R22 for serving both cooling mode and heating mode for the air conditioner, which is normally integrated into air cooled condenser as a receiver tank with sub-cooler modulator function for the embodiment illustrated in FIG. 1 and the embodiment illustrated in FIG. 5. This system is good to handle two cycles independently. However, since heat recovery heating is not available, which can have a sufficient capacity for moderate or hot region control mode operation, it is not optimum for said regions. And furthermore, to have cooling and heating functions at the same time for re-heating control mode or dehumidifying heating mode, additional air PTC heater R24 is necessary. Otherwise, electric water heater and heater core system and/or traction motor/inverter heat recovery system is necessary to provide hot water to HVAC heater R26. All above is not always necessary for said regions.

In another embodiment of present subject matter, additional cooling load can be integrated from traction motor, inverter or the like. Depending on the total heat load, the user may choose between the embodiment illustrated in FIG. 1 and the embodiment illustrated in FIG. 5.

In another embodiment of the present subject matter, as can been seen in FIG. 9, the positive temperature coefficient (PTC) heater R24 is arranged in the HVAC unit along with HVAC heater R26. Also, the accumulator R22 is arranged in refrigerant cycle R to collect liquid phase refrigerant in the surge tank C14 releasing vapour phase refrigerant to the compressor R2 to prevent back flow of the liquid and, at the same time, to keep additional refrigerant adapting to the system demand fluctuation. Further, a flow control valve R20 is also arranged between the flow path of the HVAC heater R26 and the air cooled condenser/evaporator R4. The flow control valve R20 is additionally connected with the compressor R2.

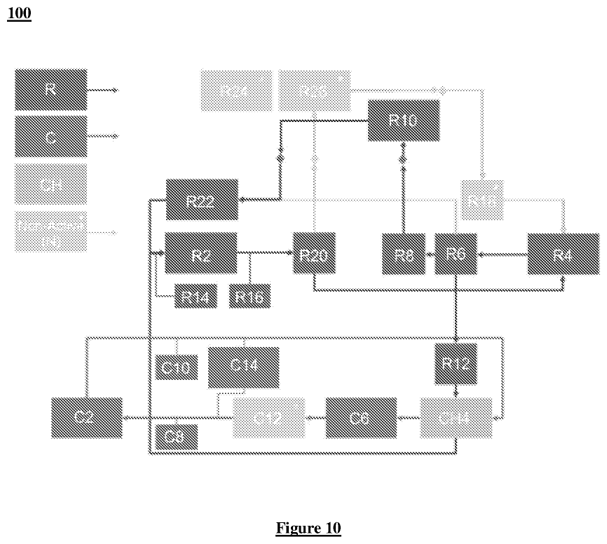

FIG. 10 illustrates a cooling mode of the electric vehicle thermal management system 100, which is typically used for cooling down period from hot cabin & battery temperature to controlled temperature, in accordance with another embodiment of the present subject matter.

In this embodiment of the present subject matter, the PTC heater R24, HVAC heater R26, and the electric heater C12 may be in non-active state.

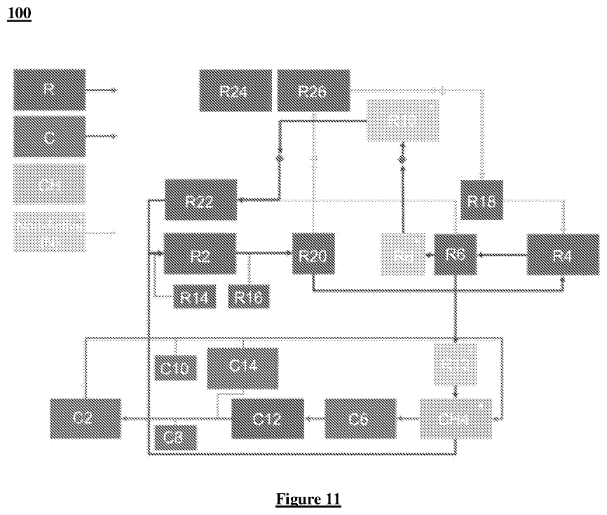

FIG. 11 illustrates a heating mode & demisting/defrosting mode of the electric vehicle thermal management system, which is typically used for pre-heating the cabin and battery, and generic heating, in winter season, in accordance with another embodiment of the present subject matter.

In this embodiment of the present subject matter, the HVAC evaporator R10 of the refrigerant cycle R and the chiller CH4 of the coolant cycle C along with their respective expansive valves R8, R12 may be in non-active state.

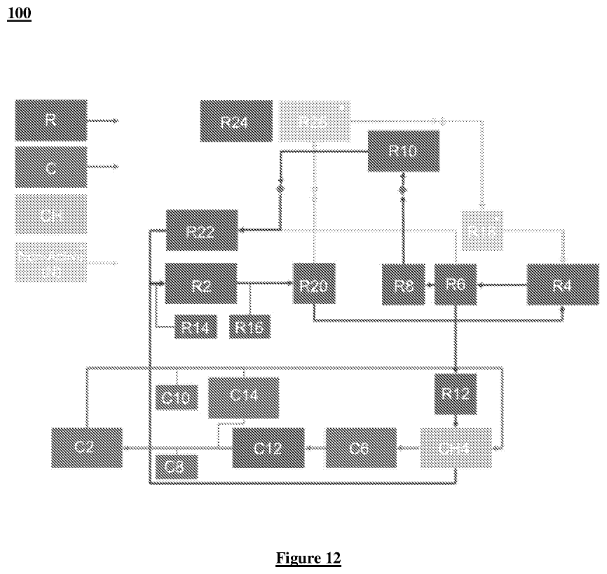

FIG. 12 illustrates a temperature control mode of the electric vehicle thermal management system 100, which is typically used for generic operation modes using active cooling and active heating using electric heater both functions at the same time, in accordance with another embodiment of the present subject matter.

In this embodiment of the present subject matter, only the HVAC heater R26 along with the expansion device R18 may be in non-active state. However, to have cooling and heating functions at the same time for re-heating control mode or dehumidifying heating mode, additional air PTC heater R24 to be operational that consumes additional electrical power. Otherwise, the electric water heater C12 and heater core system and/or traction motor/inverter heat recovery system is necessary to provide hot water to the HVAC heater R26. All above is not always necessary for said regions. This system can have active and powerful heating for all conditions, which is fully adapted with moderate or cold regions.

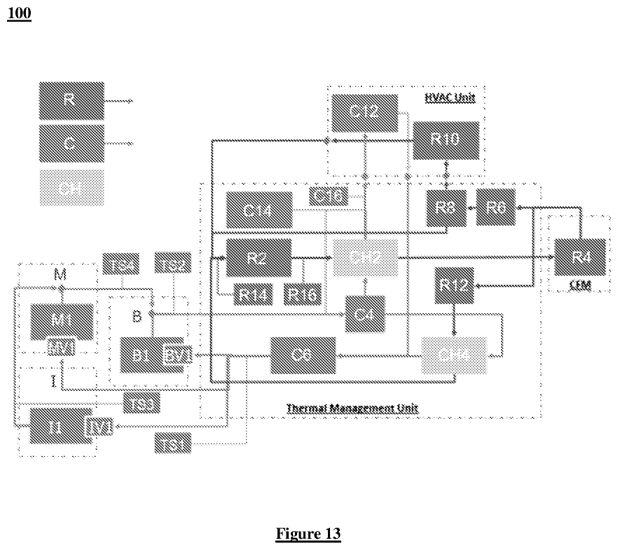

FIG. 13 illustrates the electric vehicle thermal management system 100 with Inverter heat exchanger I, I1 and traction motor heat exchanger M, M1, to have more heat recovery for heating function, in parallel in accordance with another embodiment of the present subject matter.

In another embodiment, as can be seen in FIG. 13, a motor unit M, and an inverter unit I is arranged in electric communication with the battery unit B and form a part of the cooling cycle or cooling circuit. Further, a motor valve MV1, a battery valve BV1, and an inverter valve IV1 are arranged before the motor heat exchanger M1, battery heat exchanger B1, and inverter heat exchanger I1 respectively. A plurality of temperature sensor TS1, TS2, TS3, TS4 are also arranged alongside the motor unit M, the battery unit B and the inverter unit I in the coolant cycle.

In case of more heating power necessary for the moderate regions, more heat recovery will be effective. Normally, traction motor and inverter control temperature is significantly higher than battery control temperature. That is why, those devices can be cooled by coolant using ambient air with air cooled radiator. If the capacity required is larger enough, independent power train cooling system will be adequate. If it is small enough to integrate it in FIG. 1 or FIG. 5 system, chiller and e-compressor capacities to be increased according to the additional requirement. Since hot regions do not require so much heating capacity, it could be feasible for less hot regions.

Thus, the present subject matter provides a solution for the electric vehicle thermal management system for hot climate regions of electric vehicle is using the basic principles of vapour compression refrigerant cycle and single phase coolant cycle, and comprising of one or plural electric compressors, a water cooled condenser as a common heat exchanger for two cycles, an air cooled condenser, 2 expansion devices, 1 flow control valve at coolant cycle before water cooled condenser, one or plural evaporators, one or plural heater cores, a chiller as a common heat exchanger for two cycles, one or plural battery heat exchangers, one or plural electric water pumps, a surge tank and connecting pipes.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore, contemplated that such modifications can be made without departing from the spirit or scope of the present invention as defined.

We claim:

1. An electric vehicle thermal management system 100 comprising at least one air conditioning system and a battery thermal management system, with a battery, the system comprising:
a refrigerant cycle R comprising at least one compressor R2, a first condenser CH2, a second condenser R4, expansion devices, a chiller CH4, and an evaporator R10,
wherein the compressor R2 being configured to compress refrigerant vapours by increasing temperature and pressure of a refrigerant; and
wherein the first condenser CH2 and the second condenser R4 being configured to condense high pressure and high temperature of the refrigerant; and
a coolant cycle C comprising an electric water pump C6, a battery heat exchanger C2, the first condenser CH2, and a heater C12,
wherein the electric water pump C6 being configured to pump a coolant into the coolant cycle C, the first condenser CH2 being configured to heat the coolant using the heat captured from the refrigerant cycle R and configured to transfer the heated coolant to the heater C12.

2. The electric vehicle thermal management system 100 as claimed in claim 1, wherein the compressor R2 is powered by the battery to compress refrigerant vapours by increasing temperature and pressure of refrigerant.

3. The electric vehicle thermal management system 100 as claimed in claim 1, wherein the first condenser CH2 is a common heat exchanger between the refrigerant cycle R and the coolant cycle C.

4. The electric vehicle thermal management system 100 as claimed in claim 1, wherein the first condenser CH2 is a water cooled condenser and the second condenser R4 is an air cooled condenser.

5. The electric vehicle thermal management system 100 as claimed in claim 1, wherein the refrigerant vapours flows through the first condenser CH2 and the second condenser R4 to lower the temperature and pressure of the refrigerant vapours.

6. The electric vehicle thermal management system 100 as claimed in claim 1, wherein the refrigerant vapours flows from the first condenser CH2 and the second condenser R4 to the evaporator R10 through an electric expansion device R6 and a flow control valve R8.

7. The electric vehicle thermal management system 100 as claimed in claim 1, wherein the electric water pump C6 is powered by the battery to pump the coolant into the coolant cycle C.

8. The electric vehicle thermal management system 100 as claimed in claim 1, wherein the first condenser CH2 is configured to heat the coolant using the waste heat captured by the first condenser CH2 from the refrigerant cycle R and wherein the coolant flows from the electric water pump C6 to the heater C12 through the first condenser CH2.

9. The electric vehicle thermal management system 100 as claimed in claim 1, wherein a plurality of compressors and heat exchangers are configured in the refrigerant cycle R and the coolant cycle C.

10. The electric vehicle thermal management system 100 as claimed in claim 1, wherein the refrigerant by-pass passage is configured between before the evaporator R10 and the compressor R2.

11. The electric vehicle thermal management system 100 as claimed in claim 1, wherein the second condenser R4 has an evaporator function with an additional expansion device R12.

12. The electric vehicle thermal management system 100 as claimed in claim 1, wherein the heater C12 outlet temperature coolant is controlled to lower it to the level of a battery heat exchanger C2.

13. The electric vehicle thermal management system 100 as claimed in claim 1, wherein the heater C12 outlet air temperature is controlled by a coolant flow rate control, using flow distribution control means to divide total coolant flow between heater and chiller.

14. The electric vehicle thermal management system 100 as claimed in claim 1, wherein the first condenser CH2, the flow control valve C4 and the chiller CH4 are assembled directly.

15. The electric vehicle thermal management system 100 as claimed in claim 1, wherein a surge tank C14 is configured in the coolant cycle C.

16. The electric vehicle thermal management system 100 as claimed in claim 15, wherein a phase change material is allocated in the surge tank C14 as heat storage.

17. The electric vehicle thermal management system 100 as claimed in claim 1, wherein a traction motor and/or an inverter are connected in parallel to battery to increase recovery heat.

18. The electric vehicle thermal management system 100 as claimed in claim 1 and claim 11, wherein a heat exchanger is configured to exchange heat of the refrigerant between the compressor R2 and the expansion device R6.

19. The electric vehicle thermal management system 100 as claimed in claim 1, wherein a system controller is configured to control heater core outlet air temperature by coolant flow rate control, using flow control valve, sensing heater outlet temperature, and battery inlet-outlet coolant temperature difference by coolant flow rate control, using electric pump rotation control logic, sensing compressor inlet & outlet temperature and pressure, and battery inlet coolant temperature control by compressor rotation control logic, and in-car temperature control by compressor rotation control logic, using input from in-car temperature, evaporator outlet temperature sensing data.
